(19) United States
(12) Patent Application Publication
(10) Pub. No.: US 2007/0259686 A1
(43) Pub. Date: Nov. 8, 2007

(54) Mobile communication terminal and method

(76) Inventors: Marja-Leena Nurmela, Routio (FI); Heini Tuorila, Oulu (FI); Dominick Reed, Brinkley (GB)

Correspondence Address: PERMAN & GREEN, 425 POST ROAD, FAIRFIELD, CT, 06824, US

(21) Appl. No.: 11/429,935

(22) Filed: May 8, 2006

(51) Int. Cl. H04M 1/00

(52) U.S. Cl. 455/550.1; 455/566

(57) ABSTRACT

A method for providing a user interface of a radio application of a mobile communication terminal having a display and a keypad, the radio application enabling at least one preset radio channel, the method including drawing a graphical preset indicator on the display, the graphical preset indicator including a first set of graphical preset representations, each representation of the first set of graphical preset representations corresponding to a key of the keypad, the first set of graphical preset representations being associated with a first set of preset radio stations, a layout of the first set of graphical preset representation of the graphical preset indicator corresponding to a layout of at least a subset of keys of the keypad; detecting a first user input of a key of the keypad; and tuning to a channel associated with a selected graphical preset representation corresponding to the key of the keypad. Corresponding mobile communication terminals and computer program product are also presented.

### FIELD OF THE INVENTION

The aspects of the invention generally relate to mobile terminals and more particularly to user input of radio applications of mobile terminals.

### BACKGROUND OF THE INVENTION

Mobile terminals, or mobile (cellular) telephones, for mobile telecommunications systems like GSM, UMTS, D-AMPS and CDMA2000 have been used for many years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image or video recording, FM radio, music playback, exercise analysis, electronic games, calendar/organizer/time planner, word processing, etc. Furthermore, the modern terminals have local connectivity abilities, such as Bluetooth, allowing the mobile terminals to communicate with a wide array of devices.

With so many applications available in the mobile terminal, each one needs to be intuitive and fun to use. One such application is a radio application, where usability is of great importance.

In the prior art, one attempt to simplify user interaction with the radio application is to allow the user to configure preset radio stations, where each preset radio station is associated with a number, in a manner that is similar to known car radios. The user can then tune to a particular radio station by pressing a numerical key on the keypad, which number is associated with the preset. For example, pressing the numerical key 4 will cause the radio application to tune to preset 4. While this solution somewhat improves user interaction with the radio application, the functionality is not intuitive or clearly suggested in the user interface.

Consequently, there is a need to provide a mobile communication terminal and method providing a more intuitive user interface for a radio application.

### SUMMARY OF THE INVENTION

In view of the above, an objective of the invention is to solve or at least reduce the problems discussed above.

Generally, the above objectives are achieved by the attached independent patent claims.

According to a first aspect of the invention there has been provided a method for providing a user interface of a radio application of a mobile communication terminal comprising a display and a keypad, the radio application enabling at least one preset radio channel, the method comprising: drawing a graphical preset indicator on the display, the graphical preset indicator comprising a first set of graphical preset representations, each representation of the first set of graphical preset representations corresponding to a key of the keypad, the first set of graphical preset representations being associated with a first set of preset radio stations, a layout of the first set of graphical preset representation of the graphical preset indicator corresponding to a layout of at least a subset of keys of the keypad; detecting a first user input of a key of the keypad; and tuning to a channel associated with a selected graphical preset representation corresponding to the key of the keypad.

The layout of the first set of graphical preset representation may be a grid, each graphical preset representation corresponding to one square of the grid.

The layout of the first set of graphical preset representation may be a 3 by 3 grid, each graphical preset representation corresponding to one square of the grid, and each graphical preset representation corresponding to a numerical key.

A size of the first set of graphical representation may be such that the display can show the first set of graphical representation alongside with radio information, the radio information being information selected from the group comprising a list of radio stations, text data related to a currently tuned radio station, visual data related to a currently tuned radio station, and text and visual data related to a currently tuned radio station.

The method may furthermore comprise: redrawing the graphical preset indicator, wherein the selected graphical preset representation is highlighted.

At least one of the first set of graphical preset representations may comprise an icon.

At least one of the first set of graphical preset representations may comprise at least one alphanumeric character.

The method may furthermore comprise: after detecting a second user input, redrawing the graphical preset indicator on the display, the graphical preset indicator comprising a second set of graphical preset representations, the second set of graphical preset representations being associated with a second set of preset radio stations.

The second user input may be an actuation of a ‘0’ key of the keypad.

A second aspect of the invention is a mobile communication terminal configured to provide a user interface of a radio application enabling at least one preset radio channel, the mobile communication terminal comprising a controller, a display and a keypad, wherein: the controller is configured to draw a graphical preset indicator on the display, the graphical preset indicator comprising a first set of graphical preset representations, each representation of the first set of graphical preset representations corresponding to a key of the keypad, the first set of graphical preset representations being associated with a first set of preset radio stations, a layout of the first set of graphical preset representation of the graphical preset indicator corresponding to a layout of at least a subset of keys of the keypad; the controller is configured to detect a first user input of a key of the keypad; and the controller is configured to, after detecting the first user input of a key of the keypad, tune to a channel associated with a selected graphical preset representation corresponding to the key of the keypad.

A third aspect of the invention is a mobile communication terminal configured to provide a user interface of a radio application enabling at least one preset radio channel, the mobile communication terminal comprising: a controller; a display; a keypad; means for drawing a graphical preset indicator on the display, the graphical preset indicator comprising a first set of graphical preset representations, each representation of the first set of graphical preset representations corresponding to a key of the keypad, the first set of graphical preset representations being associated with a first set of preset radio stations, a layout of the first set of graphical preset representation of the graphical preset indicator corresponding to a layout of at least a subset of keys of the keypad; means for detecting a first user input of a key of the keypad; and means for tuning to a channel associated with a selected graphical preset representation corresponding to the key of the keypad.

A fourth aspect of the invention is a computer program product comprising software instructions that, when executed in a mobile communication terminal, performs the method according to the first aspect.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated, otherwise. The steps of any method disclosed herein do not have to be performed in the exact order disclosed, unless explicitly stated.

### BRIEF DESCRIPTION OF THE DRAWINGS

Embodiments of the present invention will now be described in more detail, reference being made to the enclosed drawings, in which:

FIG. 1 is a schematic illustration of a cellular telecommunication system, as an example of an environment in which the present invention may be applied.

FIG. 2a is a schematic front view illustrating a mobile terminal according to an embodiment of the present invention.

FIG. 2b is a schematic side view illustrating the mobile terminal in FIG. 2a.

FIG. 3 is a schematic block diagram representing an internal component, software and protocol structure of the mobile terminal shown in FIG. 2a and 2b.

FIG. 4 is a schematic diagram showing how operational modes can be switched in an embodiment of the present invention.

FIGS. 5a, 5b, 5c and 5d are schematic views of embodiments of the present invention illustrating the use of a radio user interface.

### DETAILED DESCRIPTION OF THE INVENTION

The aspects of the invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

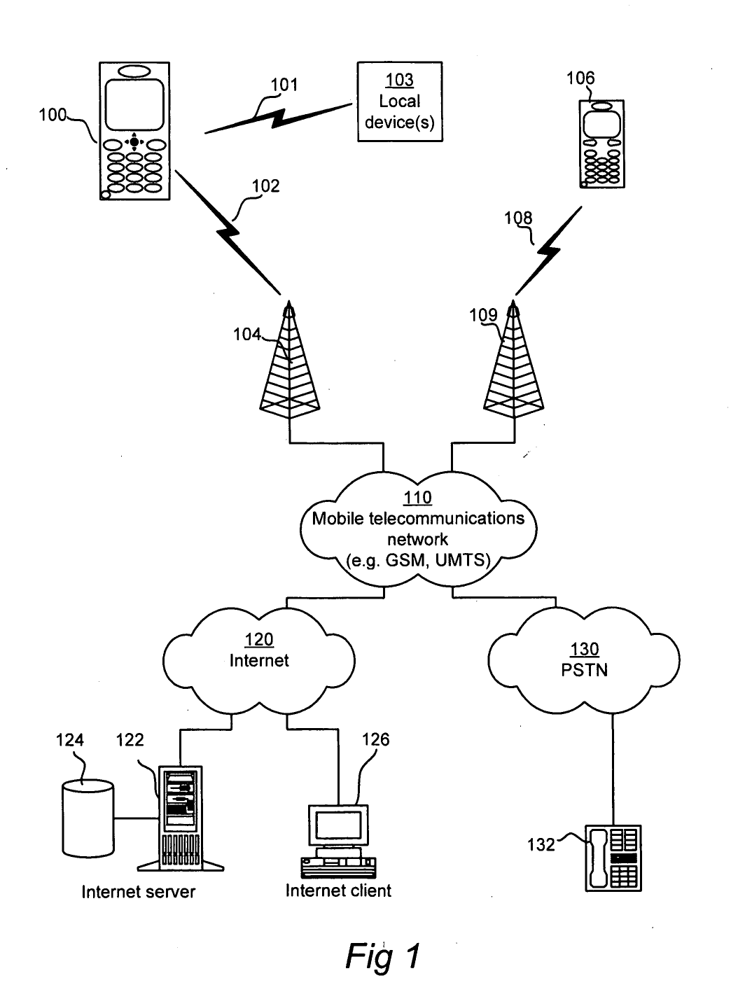

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the present invention and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, etc. The local devices 103 can for example be various sensors that can communicate measurement values to the mobile terminal 100 over the local link 101.

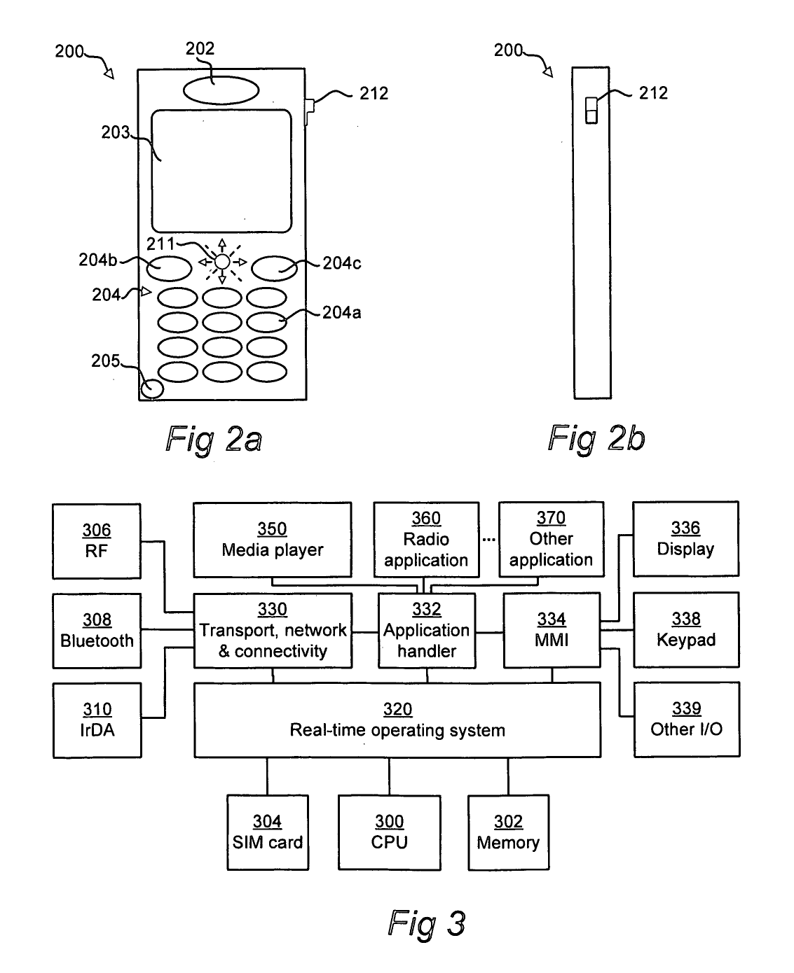

An embodiment 200 of the mobile terminal 100 is illustrated in more detail in FIG. 2a. The mobile terminal 200 comprises a speaker or earphone 202, a microphone 205, a display 203 and a set of keys 204 which may include a keypad 204a of common ITU-T type (alpha-numerical keypad representing characters “0”-“9”, “*” and “#”) and certain other keys such as soft keys 204b, 204c and a joystick 211 or other type of navigational input device.

A mode switch button 212 is also provided, as can be seen more clearly in FIG. 2b. The button is used to switch an operating mode of the mobile terminal. In this embodiment, the button is by default positioned in an upper position. When the user wants to switch modes, the button is moved to a lower position and released, after which the button returns to the default upper position by mechanical means, such as a spring or similar. As the man skilled in the art will realize, the functionality of the mode switch button could easily be replaced with a push button or any other suitable type of input device.

The internal component, software and protocol structure of the mobile terminal 200 will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data and program instructions for various software in the mobile terminal. The software includes a real-time operating system 320, drivers for a man-machine interface (MMI) 334, an application handler 332 as well as various applications. The applications can include a media player application 350, a radio application 360, as well as various other applications 370, such as applications for voice calling, video calling, sending and receiving SMS, MMS or email, web browsing, a personal exercise application, an instant messaging application, a phone book application, a calendar application, a control panel application, a camera application, one or more video games, a notepad application, etc.

The MMI 334 also includes one or more hardware controllers, which together with the MMI drivers cooperate with the display 336/203, keypad 338/204 as well as various other I/O devices such as microphone, speaker, vibrator, ringtone generator, LED indicator, etc. As is commonly known, the user may operate the mobile terminal through the man-machine interface thus formed.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1). As is well known to a man skilled in the art, the radio circuitry comprises a series of analogue and digital electronic components, together forming a radio receiver and transmitter. These components include, i.a., band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

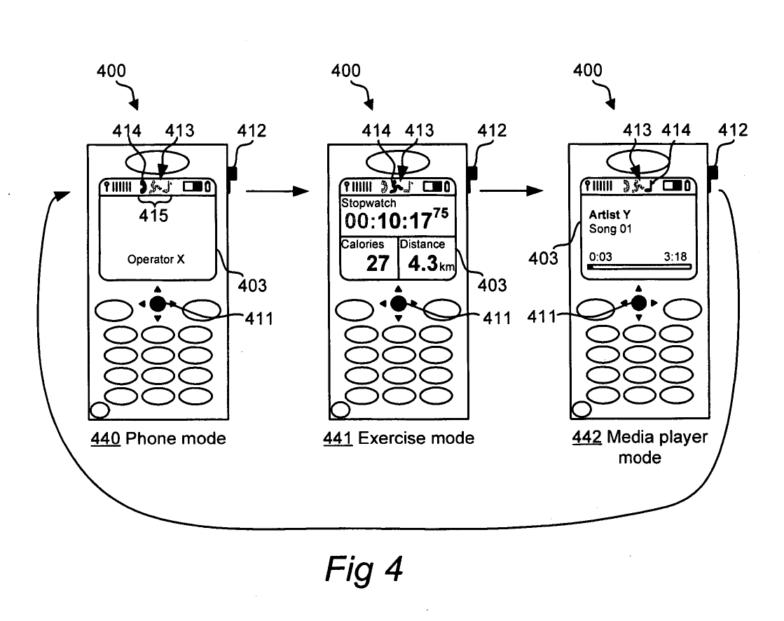

FIG. 4 shows how operational modes can be switched in an embodiment of the present invention. The mobile terminal 400, such as mobile terminal 200 of FIG. 2a, comprises a display 403, such as display 203 of FIG. 2a, a joystick 411, such as joystick 211 of FIG. 2a, and a mode switch button 412 such as mode switch button 212 of FIG. 2a to allow the user to switch operational modes.

Operational modes are modes where the mobile terminal 400 behaves in a specific way. For example, FIG. 4 shows 3 operational modes: a phone mode 440, an exercise mode 441 and a media player mode 442.

When the mobile terminal 400 is in the phone mode 440, the mobile terminal behaves as a user would expect a regular mobile terminal to behave. In other words, a menu system and/or shortcuts allow the user to instruct the mobile terminal to perform a desired function, such as voice telephony, www/wap browsing, video telephony, electronic messaging (e.g. SMS, MMS, email, instant messaging), digital image or video recording, electronic games, calendar/organizer/time planner, word processing, etc.

When the mobile terminal 400 is in the exercise mode 441, the main purpose of the mobile terminal is to provide the user with applications related to the physical exercise of the user.

In one embodiment, an accelerometer is integrated in the mobile terminal 400. In another embodiment, an external accelerometer is connected to the mobile terminal 400, e.g. over a local link, such as the local link 101 in FIG. 1. The accelerometer can detect acceleration and thereby steps that the user takes while the mobile terminal is carried by the user. When an accelerometer is integrated or connected to the mobile terminal 400, the mobile terminal automatically measures movement during the day. If the user previously has entered personal information, such as weight, height, etc., the mobile terminal 400 can convert the data from the accelerometer to other measurements, such as covered distance and burnt calories. Optionally, a GPS (Global Positioning System) sensor can be either integrated in, or connected to, the mobile terminal 400 to allow accurate distance measurement. Also, an external heart beat monitor can be connected to the mobile terminal 400 to detect heart beats and calculate heart rate.

When the mobile terminal 400 is in the media player mode 442, the one purpose of the mobile terminal is to play media to the user. For example, the media player can play music or sound files, such as MP3 (mpeg-1 audio layer 3) files, AAC (advanced audio coding) files or ogg files. Additionally, the media player can also be used to listen to FM (frequency modulated) radio using a radio application, and optionally also to play video files according to standards such as MPEG-2, MPEG-4 or H.323.

As the user switches operational modes with mode switch button 412, the modes are switched serially. In the illustrated embodiment, there is a list of operational modes consisting of the phone mode 440, the exercise mode 441, and the media player mode 442, in that order. Consequently, if the mobile terminal 400 is in the phone mode 440 and the user actuates the mode switch button 412, the phone switches to the exercise mode 441. Similarly, if the mobile terminal 400 is in the exercise mode 441 and the user actuates the mode switch button 412, the phone switches to the media player mode 442. Finally, if the mobile terminal 400 is in the media player mode 443 and the user actuates the mode switch button 412, the phone loops back and switches to the phone mode 440.

To allow the user to easily determine what mode is currently used, elements of the user interface are specific for each mode. There are a multitude of distinguishing user interface elements that can vary to allow the user to see what mode is currently active, e.g., a centrally located light by the joystick 411 can change color, the background on the display 403 can have different colors or appearances, or the entire theme of the user interface with colors and fonts can change. In one embodiment, one icon 414 of a set of icons 415 at the top of the display 403 is highlighted to indicate which mode is active.

Mode changes can also change sound effects. For example in phone mode 440, the sounds may be discrete or even absent for actions such as button press, enter menu, exit menu, while in exercise mode 441, distinct and loud sounds are played for these actions to give clear feedback to the user while exercising. The media player mode 441 may have a totally different, more cool or ambient sound scheme on the actions mentioned in order to give feedback to the user on actions performed, while still not excessively disturbing the experience of listening to music. Optionally, the sound scheme can furthermore vary depending on whether headphones are connected to the mobile terminal 400 or not. The changes of sounds does not need to be totally different sounds; the changes could be effects applied to sounds. For example, a sound for a button press in phone mode could be reused in the media player mode, with a strong reverberation effect on it to give a more ambient effect while still providing familiarity to the user.

Additionally, a temporary user indication can be given when the actual mode change occurs. For example, the vibrator may vibrate on a mode change, where the vibration is either always identical for all modes or every mode has a particular vibration associated with it. Additionally, a dialog can show the name of the new operational mode in the display 403, or a sound effect or speech synthesizer pronouncing the new mode can be played to the user.

It is to be noted that although the modes can be switched certain appropriate processing of an inactive mode can still be performed. For example, the exercise application can count the steps of the user in the background, regardless of what mode the mobile terminal is in. Similarly, the media player can let the user hear an FM radio station while the mobile terminal is in exercise mode, or the phone application can temporarily interrupt current processing if there an incoming phone call is detected.

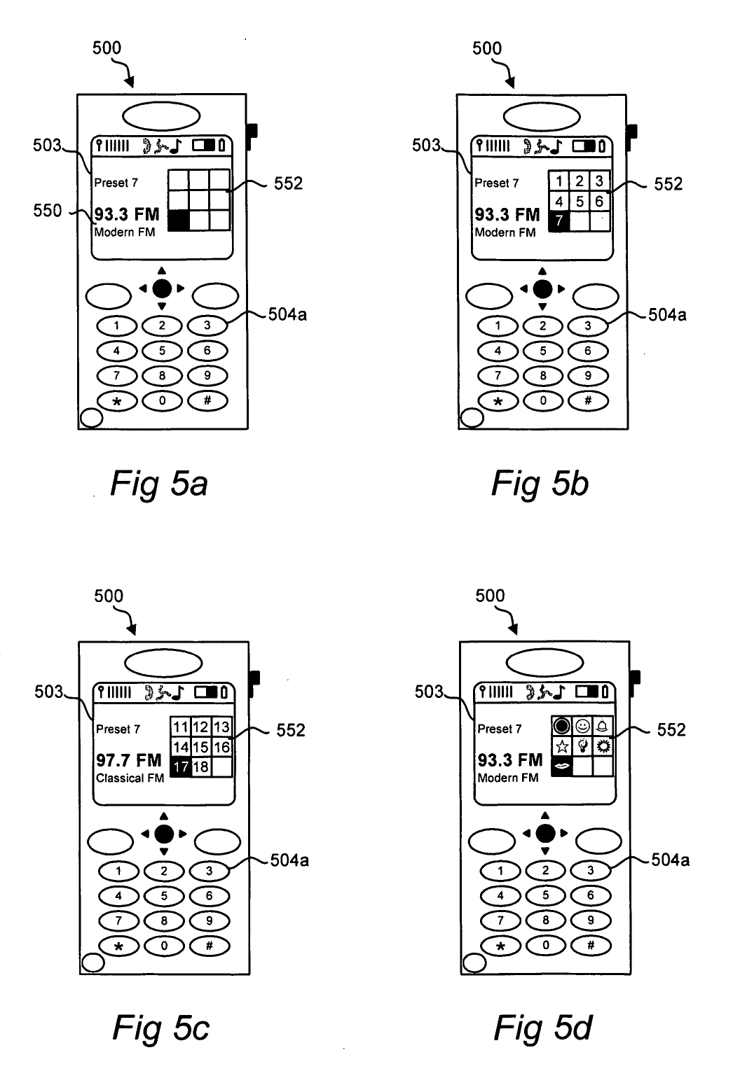

FIGS. 5a, 5b, 5c and 5d are schematic views of embodiments of the present invention illustrating the use of a radio user interface.

In FIG. 5a, a radio application, such as radio application 360 of FIG. 3, of the mobile terminal 500 is currently tuned to a radio station, as can be seen on the display 503. The display shows text information 550 on the left and a graphical preset indicator 552 on the right of the display.

The text information 550 includes information about the number of the current preset, “Preset 7” in this example, the currently tuned frequency, “93.3 FM” in this example, and text information about the currently tuned radio station, “Modern FM” in this example. The text information about the currently tuned radio station could be picked up from Radio Data System (RDS) data transmitted over the air, or the user could enter text data when the preset is saved or edited. Note that although frequency is used to tune to a channel in this example, any way to address a channel among a plurality of potential channels can be used, such selecting a code in a code multiplexed signal, selecting a channel in a time multiplexed signal, or a combination of these.

The graphical preset indicator 552 shows a layout of presets, as they are related to keys of the keypad 504a. Here the graphical preset indicator 552 is a grid, where each square in the grid is a graphical representation of a preset. Consequently, there are 9 presets represented in the graphical preset indicator 552 shown here. Each square is associated with a key in a corresponding position of the keypad 504a, such that the top left square is associated with the key “1”, the top middle square is associated with the key “2”, the top right square is associated with the key “3”, the middle left square is associated with the key “4”, the middle square is associated with the key “5”, the middle right square is associated with the key “6”, the bottom left square is associated with the key “7”, the bottom middle square is associated with the key “8”, and the bottom right square is associated with the key “9”. The square corresponding to the number of the currently selected preset, preset number 7 in this example, is highlighted.

This allows the user to easily understand that each numerical key of the keypad is associated with a preset of the radio application. When the user presses a numerical key, the radio application responds by tuning to the channel of the preset, associated with the key pressed by the user.

In FIG. 5b, the graphical preset indicator 552 has been enhanced to also show numbers in the squares where a corresponding preset is available. Consequently, in the example shown here, presets are saved in positions 1 to 7, while positions 8 and 9 have no presets saved.

In FIG. 5c, the graphical preset indicator 552 shows squares representing presets in positions 11 to 18. This is a second group of presets, compared to the presets shown in FIG. 5b showing a first group of presets. The user can switch between the two groups of presets using a change preset group input, for example, the ‘0’ key of the keypad 504a. There can be a number of preset groups, whereby the user can cycle through the preset groups with the change preset group input.

FIG. 5d shows a graphical preset indicator 552, where each square shows an icon corresponding to the preset associated with it.

Instead of using the numerical keys to directly tune to a specific preset, browse buttons can be used to browse up and down the list of presets. For example, the ‘#’ key of the keypad 504a could be used to skip to the next preset, and the “*” key could be used to skip to the previous preset.

While it is here described a graphical preset indicator being a grid, the graphical preset indicator can equally well be any shape corresponding to a layout of keys. For example, the graphical preset indicator could be a circle of preset representations if the keys of the keypad are laid out in a circle.

The invention has mainly been described above with reference to a few embodiments. However, as is readily appreciated by a person skilled in the art, other embodiments than the ones disclosed above are equally possible within the scope of the invention, as defined by the appended patent claims.

What is claimed is:

1. A method for providing a user interface of a radio application of a mobile communication terminal comprising a display and a keypad, said radio application enabling at least one preset radio channel, said method comprising:
drawing a graphical preset indicator on said display, said graphical preset indicator comprising a first set of graphical preset representations, each representation of said first set of graphical preset representations corresponding to a key of said keypad, said first set of graphical preset representations being associated with a first set of preset radio stations, a layout of said first set of graphical preset representation of said graphical preset indicator corresponding to a layout of at least a subset of keys of said keypad;
detecting a first user input of a key of said keypad; and
tuning to a channel associated with a selected graphical preset representation corresponding to said key of said keypad.

2. The method of claim 1, wherein said layout of said first set of graphical preset representation is a grid, each graphical preset representation corresponding to one square of said grid.

3. The method of claim 1, wherein said layout of said first set of graphical preset representation is a 3 by 3 grid, each graphical preset representation corresponding to one square of said grid, and each graphical preset representation corresponding to a numerical key.

4. The method of claim 1, wherein a size of said first set of graphical representation is such that said display can show said first set of graphical representation alongside with radio information, said radio information being information selected from the group comprising a list of radio stations, text data related to a currently tuned radio station, visual data related to a currently tuned radio station, and text and visual data related to a currently tuned radio station.

5. The method of claim 1, furthermore comprising:
redrawing said graphical preset indicator, wherein said selected graphical preset representation is highlighted.

6. The method of claim 1, wherein at least one of said first set of graphical preset representations comprises an icon.

7. The method of claim 1, wherein at least one of said first set of graphical preset representations comprises at least one alphanumeric character.

8. The method of claim 1, furthermore comprising:
after detecting a second user input, redrawing said graphical preset indicator on said display, said graphical preset indicator comprising a second set of graphical preset representations, said second set of graphical preset representations being associated with a second set of preset radio stations.

9. The method of claim 8, wherein said second user input is an actuation of a ‘0’ key of said keypad.

10. A mobile communication terminal configured to provide a user interface of a radio application enabling at least one preset radio channel, said mobile communication terminal comprising a controller, a display and a keypad, wherein:
said controller is configured to draw a graphical preset indicator on said display, said graphical preset indicator comprising a first set of graphical preset representations, each representation of said first set of graphical preset representations corresponding to a key of said keypad, said first set of graphical preset representations being associated with a first set of preset radio stations, a layout of said first set of graphical preset representation of said graphical preset indicator corresponding to a layout of at least a subset of keys of said keypad;
said controller is configured to detect a first user input of a key of said keypad; and
said controller is configured to, after detecting said first user input of a key of said keypad, tune to a channel associated with a selected graphical preset representation corresponding to said key of said keypad.

11. A mobile communication terminal configured to provide a user interface of a radio application enabling at least one preset radio channel, said mobile communication terminal comprising:
a controller;
a display;
a keypad;
means for drawing a graphical preset indicator on said display, said graphical preset indicator comprising a first set of graphical preset representations, each representation of said first set of graphical preset representations corresponding to a key of said keypad, said first set of graphical preset representations being associated with a first set of preset radio stations a layout of said first set of graphical preset representation of said graphical preset indicator corresponding to a layout of at least a subset of keys of said keypad;
means for detecting a first user input of a key of said keypad; and
means for tuning to a channel associated with a selected graphical preset representation corresponding to said key of said keypad.

12. A computer program product comprising software instructions that, when executed in a mobile communication terminal, performs the method according to claim 1.
